(19) United States
(12) Patent Application Publication
(10) Pub. No.: US 2007/0269787 A1
(43) Pub. Date: Nov. 22, 2007

(54) METHOD AND SYSTEM FOR RECOMMENDING MEDIA CONTENT TO A USER OF A MOBILE RADIO TERMINAL

(76) Inventor: David S Cronstrom, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/379,831

(22) Filed: Apr. 24, 2006

(51) Int. Cl. G09B 3/00

(52) U.S. Cl. 434/350

(57) ABSTRACT

A method of making a user specific media content recommendation to a user of a mobile radio terminal that is configured to receive media content. The media content is made available by a media content provider to plural mobile radio terminals. Content selection behavior of a group of content consumers for the media content using respective mobile radio terminals is monitored to build a database of content selection patterns. Content selection behavior of the user is monitored to establish a user content selection pattern. The user content selection pattern is matched to a content selection pattern from the database of content selection patterns to generate the user specific media content recommendation from the matched content selection pattern. The content recommendation identifies content selected by content consumers associated with the matched content selection pattern.

### TECHNICAL FIELD OF THE INVENTION

The present invention relates generally to electronic equipment, such as electronic equipment for engaging in voice communications and/or for playing back audiovisual content to a user. More particularly, the invention relates to a method and system for recommending media content to a user of a mobile radio terminal.

### DESCRIPTION OF THE RELATED ART

Mobile and/or wireless items of electronic equipment are becoming increasingly popular. For example, mobile telephones are now in wide-spread use. In addition, the features associated with certain types of electronic equipment have become increasingly diverse. To name a few examples, many electronic equipment include cameras, text messaging capability, Internet browsing functionality, electronic mail capability, video playback capability, audio playback capability, image display capability and hands-free headset interfaces.

Some items of electronic equipment include mobile television and/or mobile radio capability. For example, mobile items of electronic equipment may be able to receive and display video content, along with outputting associated audio content. For instance, such electronic equipment may be compatible with the Digital Video Broadcasting-Handheld (DVB-H) standard for bringing broadcast services to handheld receivers. The DVB-H standard was formally adopted as ETSI standard EN 302 304 in November 2004 and is herein incorporated by reference in its entirety. DVB-H, which falls within the set of DVB transmission standards, adapts the DVB-T system for digital terrestrial television for use with handheld, battery-powered devices. DVB-H can offer a downstream channel at high data rates for use by standalone devices or as an enhancement to mobile telecommunications networks. As will be appreciated, mobile telecommunications networks are traditionally used to provide services such as telephone communications, messaging and/or Internet access to various items of electronic equipment.

Audiovisual content also may be delivered through a podcast delivered to the device in a feed format such as really simple syndication (RSS) or Atom syndication. It is noted that RSS may equally refer to other podcasting standards, such as rich site summary (RSS 0.91), resource description framework (RDF) site summary (RSS 0.9 and 1.0) and real-time simple syndication (RSS 2.0).

Regardless of the manner in which the audiovisual content is delivered to the mobile device, the user may have a large number of content choices from a service provider. For instance, mobile television channels available to the user may easily exceed a hundred channels. The user may not be interested in temporarily selecting each channel (e.g., “zapping” or “surfing” through channels) to find a channel of interest. In other situations, the user may travel to a location where the available content differs from that normally available to the user. In these situations the user may not be aware of content that may be of interest or when content of interest is offered.

### SUMMARY

According to one aspect of the invention, a method of making a user specific media content recommendation to a user of a mobile radio terminal that is configured to receive media content, the media content made available by a media content provider to plural mobile radio terminals, includes monitoring content selection behavior of a group of content consumers for the media content using respective mobile radio terminals, and building a database of content selection patterns; monitoring content selection behavior of the user and establishing a user content selection pattern; and matching the user content selection pattern to a content selection pattern from the database of content selection patterns, and generating the user specific media content recommendation from the matched content selection pattern, wherein the content recommendation identifies content selected by content consumers associated with the matched content selection pattern.

According to another aspect, the method further includes transmitting the content recommendation to the mobile radio terminal of the user.

According to another aspect, the media content is mobile television channels and the monitoring of user and group content selection behavior monitors channel viewing choices.

According to another aspect, the building the database places each content selection into one of a predetermined set of content categories and each content selection pattern is indicative of one or more categories frequently selected by a subgroup of content consumers.

According to another aspect, the recommendation identifies an alternative content for content selected by the user and the alternative is categorized in the same category as the content selected by the user.

According to another aspect, the recommendation identifies content from a category different than a category for content selected by the user.

According to another aspect, the mobile radio terminal of the user is a mobile telephone.

According to another aspect, the mobile telephone includes an IP datacast compatible receiver.

According to another aspect, the matching includes matching the user content selection pattern to a content selection pattern associated with media consumers having at least one of a demographic profile, a market segment profile, a connection type or a device type that overlaps with a corresponding demographic profile, market segment profile, connection type or device type of the user.

According to another aspect of the invention, a program stored on a machine usable medium for making a user specific media content recommendation to a user of a mobile radio terminal that is configured to receive media content, the media content made available by a media content provider to plural mobile radio terminals, includes executable logic to monitor content selection behavior of a group of content consumers for the media content using respective mobile radio terminals, and build a database of content selection patterns; monitor content selection behavior of the user and establish a user content selection pattern; and match the user content selection pattern to a content selection pattern from the database of content selection patterns, and generate the user specific media content recommendation from the matched content selection pattern, wherein the content recommendation identifies content selected by content consumers associated with the matched content selection pattern.

According to another aspect, a server configured to make a user specific media content recommendation to a user of a mobile radio terminal that is configured to receive media content, the media content made available by a media content provider to plural mobile radio terminals, includes a processor that executes logic to monitor content selection behavior of a group of content consumers for the media content using respective mobile radio terminals, and build a database of content selection patterns; monitor content selection behavior of the user and establish a user content selection pattern; and match the user content selection pattern to a content selection pattern from the database of content selection patterns, and generate the user specific media content recommendation from the matched content selection pattern, wherein the content recommendation identifies content selected by content consumers associated with the matched content selection pattern.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile telephone as an exemplary electronic equipment in accordance with an embodiment of the present invention;

FIG. 2 is a schematic block diagram of the relevant portions of the mobile telephone of FIG. 1 in accordance with an embodiment of the present invention;

FIG. 3 is a schematic diagram of a communications system in which the mobile telephone of FIG. 1 may operate; and

FIG. 4 is a flow chart of an exemplary media content recommendation function in accordance with the present invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like. Other exemplary electronic equipment and mobile radio terminals may include, but are not limited to, portable media players, media jukeboxes and similar devices having a radio transceiver.

In the present application, the invention is described primarily in the context of a mobile telephone. However, it will be appreciated that the invention is not intended to be limited to a mobile telephone and can be any type of electronic equipment.

The term channel will be used to broadly mean any one of multiple broadcast services that may be received by the electronic equipment. Accordingly, each channel may correspond to a television station or a radio station. Channels may also correspond to a set of programs offered by a television, video, radio, music and/or other content service (e.g., there may be one service provider that offers a number of programs, such as in the form of a play list). As will be appreciated, each channel delivers corresponding audiovisual content. The content may change over the course of time (e.g., a news program may be followed by a sporting event, which is followed by movie). A receiver (e.g., a DVB-H receiver) of the electronic equipment 10 may be “tuned” to one of the channels. It is noted that under the DVB-H standard, each channel may be referred to as a service. The channel to which the receiver is tuned is typically selected by the user. Audiovisual content may be received in other manners, such as by podcasts. Accordingly, media content and media content recommendations may relate to any mobile media format or content type including, but not limited to, mobile television, mobile radio, internet radio channels, podcasts, RSS feeds, Internet webpages, video clips, audio clips, audio books, animations, ring tones, commercials and so forth.

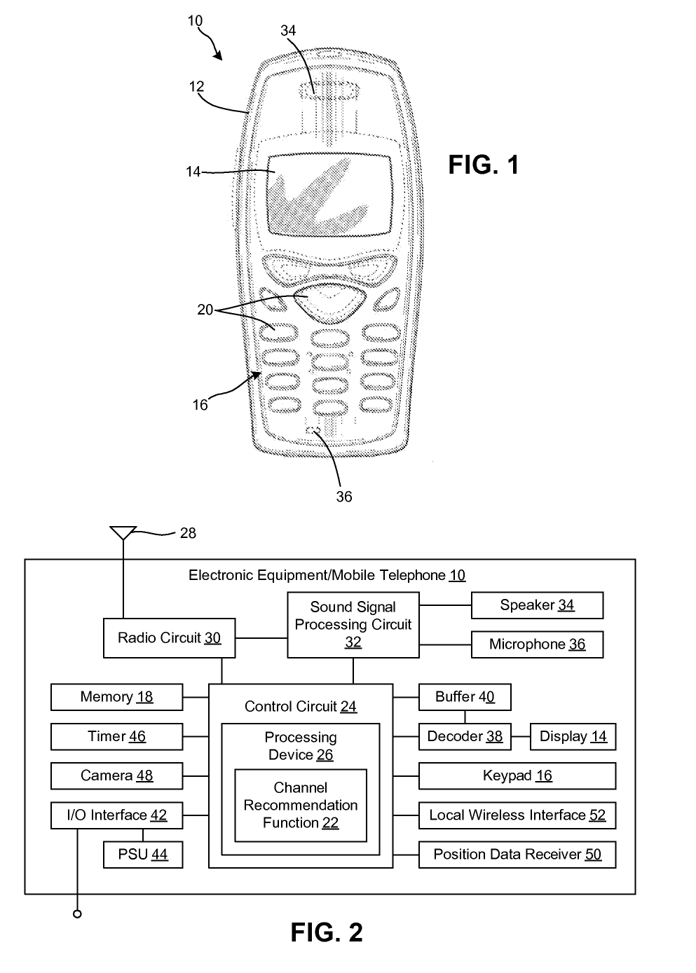

Referring initially to FIG. 1, an electronic equipment 10 is shown in accordance with the present invention. The electronic equipment includes a channel recommendation function that is configured to provide a user with media content recommendations. In environments where content may be delivered through mechanisms other than or in addition to a channel based mechanism, the channel recommendation function may be referred to as a media or content recommendation function. It will be appreciated that the channel recommendation function may be embodied as executable code that may be resident in and executed by the electronic equipment 10.

The electronic equipment in the exemplary embodiment is a mobile telephone and will be referred to as the mobile telephone 10. The mobile telephone 10 is shown as having a “brick” or “block” form factor housing 12, but it will be appreciated that other type housings, such as a clamshell housing or a slide-type housing, may be utilized without departing from the scope of the invention.

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. With the exception of a channel recommendation function 22, which is preferably implemented as executable logic in the form of application software or code within the mobile telephone 10, the construction of the mobile telephone 10 is otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out conventional operation of the mobile telephone 10. The memory 18 may be, for example, one or more of a buffer, a flash memory, a hard drive, a removable media, a volatile memory, a non-volatile memory or other suitable device. In addition, the processing device 26 executes code in order to perform the channel recommendation function 22.

It will be apparent to a person having ordinary skill in the art of computer programming, and specifically in applications programming for mobile telephones or other items of electronic equipment, how to program a mobile telephone 10 to operate and carry out the functions described herein. Accordingly, details as to the specific programming code have been left out for sake of brevity. Also, while the channel recommendation function 22 is executed by the processing device 26 in accordance with the preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system, as well as to receive audiovisual content. For example, the receiver may be an IP datacast compatible receiver compatible with a hybrid network structure providing mobile communications and DVB-H based or similar services. Other receivers for interaction with a mobile radio network or broadcasting network are possible and include, for example, GSM, CDMA, WCDMA, MBMS, WiFi, WiMax, DVB-H, ISDB-T, etc.

The mobile telephone 10 further includes a sound signal processing circuit 32 for processing audio signals transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. The display 14 may be coupled to the control circuit 24 by a video decoder 38 that converts video data to a video signal used to drive the display 14. The video data may be generated by the control circuit 24, retrieved from a video file that is stored in the memory 18 or derived from an incoming video data stream received by the radio circuit 30. Prior to being feed to the decoder 38, the video data may be buffered in a buffer 40.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown). Further, the I/O interface(s) 42 may serve to connect the mobile telephone 10 to a personal computer or other device via a data cable. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include timing the durations of calls, generating the content of time and date stamps, etc. The mobile telephone 10 may include a camera 48 for taking digital pictures and/or movies. Image and/or video files corresponding to the pictures and/or movies may be stored in the memory 18. The mobile telephone 10 also may include a position data receiver 50, such as a global positioning system (GPS) receiver, Galileo satellite system receiver or the like. The mobile telephone 10 also may include a local wireless interface 52, such as an infrared transceiver and/or an RF adaptor (e.g., a Bluetooth adapter), for establishing communication with an accessory, hands-free adaptor, another mobile radio terminal, computer or other device.

The mobile telephone 10 may be configured to transmit, receive and process data, such as text messages (e.g., a short message service (SMS) formatted message), electronic mail messages, multimedia messages (e.g., a multimedia messaging service (MMS) formatted message), image files, video files, audio files, ring tones, streaming audio, streaming video and so forth. Processing such data may include storing the data in the memory 18, executing applications to allow user interaction with data, displaying video and/or image content associated with the data, broadcasting audio sounds associated with the data and so forth.

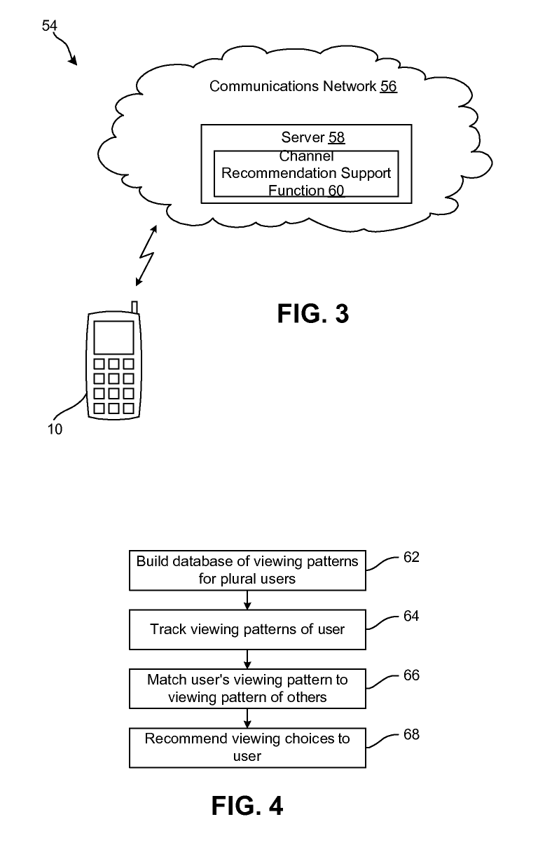

With additional reference to FIG. 3, the mobile telephone 10 may be configured to operate as part of a communications system 54. The system 54 may include a communications network 56 having a server 58 (or servers) for managing calls placed by and destined to the mobile telephone 10, transmitting data to the mobile telephone 10 and carrying out any other support functions. The server communicates with the mobile telephone 10 via a transmission medium. The transmission medium may be any appropriate device or assembly, including, for example, a communications tower, another mobile telephone, a wireless access point, a satellite, etc. Portions of the network may include wireless transmission pathways. The network 56 may support the communications activity of multiple mobile telephones 10, although only one mobile telephone 10 is shown in the illustration of FIG. 3.

In one embodiment, the server 58 may operate in stand alone configuration relative to other servers of the network 52 or may be configured to carry out multiple communications network 58 functions. As will be appreciated, the server 58 may be configured as a typical computer system used carry out server functions and may include a processor configured to execute software containing logical instructions that embody the functions of the server 58. Those functions may include functions that are complimentary to the operation of the channel recommendation function 22 of the mobile telephone 10, and will be collectively referred to as a channel recommendation support function 60.

Referring to FIG. 4, a method of recommending media content to a user of the mobile telephone 10 is depicted. The exemplary method of FIG. 4 describes the recommendation of mobile television channels to the user. It will be appreciated that the method may be adapted to recommend radio stations and/or other forms of content delivery, such as podcasts, to the user. Therefore, while the description herein refers to the recommendation of television programming to the user, the invention is not limited a single type of media or content delivery mechanism. Portions of the functionality of the method may be carried out by the mobile telephone 10 and portions of the functionality of the method may be carried out by the server 58. For example, the functionality of the method may be embodied as executable code, such as in the form of the channel recommendation function 22 and/or the channel recommendation support function 60, or any other suitable form, including software, firmware, dedicated circuit components, a program stored on a computer readable media or in machine usable medium, and so forth.

Although the illustrated method shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 62 where a database of viewing patterns for a plurality of mobile television viewers is established. The viewers may be all viewers subscribing to a mobile television service offered by an operator of the communications network. In another embodiment, the viewers for block 62 may be a select group of viewers and/or viewers who have agreed to have their viewing activity monitored for construction of the database. In one embodiment, the functions of block 62 may be carried out by the channel recommendation support function 60 executed by the server 58. When the method is adapted to provide media content recommendations for media other than or in addition to mobile television, the viewers may be referred to as media or content consumers and the monitoring of viewing patterns may be referred to as monitoring content selection behavior.

In block 62, viewing activity of the viewers is monitored to find patterns in the channel and/or the type of content that viewers tend to watch. For example, certain viewers who often choose to watch a particular channel dedicated to sports may also watch another channel dedicated to sports. As another example, by observing behavior and identifying patterns, it may be found that viewers who watch movies on a regular basis may also watch channels dedicated to fashion and celebrity news. As another example, viewers who watch one news service may also watch a second news service, but not a third news service.

The database generation may include observing viewing patterns based on viewer demographics. For example, categories of viewers by age, gender, race, nationality and so forth may be established as part of the database so that viewing patterns by demographic group may be established. The database generation may include observing viewing patterns based on market segmentation (including one or more parameter such as psychographics, geographies (viewer location), language, etc.), connection type and/or device type. Tracking market segmentation may enable the establishment of viewing patterns by market segment. Tracking connection type and/or device type may assist in making content recommendations for which the user's device can receive and/or play back (e.g., to avoid recommending media available only via DMB to a user that has DVB-H and not DMB).

Of course, observing viewer behavior and identifying patterns in the channels and/or content selected by viewers can be carried out in a number of different ways. Exemplary techniques are described herein, but other techniques and/or modifications to the described techniques are possible and are considered to be suitable techniques. The channel recommendation support function 60 may rely on only one technique to build the database or plural techniques to build the database. Also, multiple techniques may be combined by merging the processes.

An example technique for finding viewing patterns is to observe the choices that the viewers have a propensity to make. For example, monitoring of user behavior may reveal that a viewer or viewers have a pattern (e.g., “modus operandi”) when making channel selection, such as selecting from only a few channels from a larger number of available channels when attempting to find content of interest. Monitoring may reveal that channels tend to be selected based on types of offered content, in a particular order and/or with a particular frequency. Other observable behavior may include observing the types of channel selections that the viewers make based on the time of day and/or day of the week. As will be appreciated, various additional and/or alternative statistical analysis techniques may be used to assess viewer behavior.

In one embodiment, the particular channels of most interest to a viewer are determined and used to generate a “favorites” style channel selection list on a viewer by viewer basis. The data for each viewer may be statistically combined to generate viewing patterns. In a variant technique, the viewers may personally define a list of their favorite channels to view. Different lists may be generated for different times of day and/or different days of the week.

Another example data collection technique may involve monitoring the popularity of a channel, such as by using Nielson ratings, the accumulated view time of each available channel, the number of viewers who watch a channel and so forth. Monitoring accumulated view time and/or accumulated frequency with which viewers have historically selected each available channel for viewing may reveal that viewers tend to watch certain channels over other channels. For instance, based on one or more of these parameters, a score or percentage value may be associated with each channel. Static rating may be used to rank each channel according to overall viewership across all time slots. Dynamic ratings may be used to rank each channel according to viewership at the particular time to take into consideration the popularity of content aired at particular times. Therefore, dynamic ratings would rank the most popular channel for the particular time ahead of other channels, even if that channel is not as popular at other times.

Data collection may include a content based metric. This technique is used to observe the particular programming or a particular type of content that the viewer views often or with regularity. For example, it is possible to monitor for viewer selection of recurring shows or program series. Thus, this metric is based on type of content and monitored behavior. Categories of regularly watched content and how often or frequently each are watched may be developed. An example set of categories could include sporting events in general, particular types of sports (e.g., football/soccer, American football, basketball, etc.), particular sporting teams, news programs in general, particular types of news programs (e.g., national news, local news, business and financial news, etc.), cooking shows, music videos, and so forth.

As indicated, the techniques to establish viewing patterns may be based on monitored viewer behavior, time of day and/or day of the week, viewer demographics, market segmentation, connection type, device type, etc. Aspects from one or more techniques may be merged with or integrated in another technique. Accordingly, each technique should be considered combinable with every other technique. Aspects of each technique may be tuned over time to improve accuracy of the pattern recognition.

From the monitoring of viewing behavior, patterns may be identified to find common viewing habits among groups of viewers. Using the assumption that a viewer who has overlapping viewing habits as a group of viewers may enjoy watching content selected by others in that group, the method may establish viewing recommendations for the user as explained in greater detail below.

With continued reference to FIG. 4, in block 64, the viewing patterns of the user of the mobile telephone 10 are monitored and ascertained. The monitoring may be made as part of the monitoring made in block 62, but on an individualized basis. As such, any one or combination of behavior monitoring techniques described above may be employed for monitoring the user's behavior and establishing viewing tendencies of the user. The monitoring may be carried out by the channel recommendation function 22 resident in the mobile telephone 10 and/or by the channel recommendation support function 60 of the server 58. If the monitoring is carried out in the mobile telephone 10, results of the monitoring may be transmitted to the server 10 for use in developing the database of content selection patterns and/or to match user behavior (e.g., in the form of a content selection pattern) with the content selection patterns of others.

Resulting from block 64 may be an assessment of the user's viewing behavior. For example, the channels selected by the user and/or the type of content selected by the user may be determined. The viewing behavior may be determined for individual time slots. From the assessment, the types of channels and/or content that the user most often views may be determined. The types of channels and/or content may be categorized using the categories of channels and/or content into which the habits of multiple viewers are categorized in block 62. Example categories include sports and types of sports programming, news and types of news programming, drama shows, comedy shows, detective shows, animated shows, music videos, reality shows, and so forth.

Proceeding to block 66, the channel recommendation function 22 and/or the channel recommendation support function 60 may compare the user's viewing pattern determined in block 64 to the patterns of plural users established in block 62. The comparison may establish matches between the user's behavior and that of others. The comparison may include comparing the user's viewing statistics with the viewing statistics of the other viewers in general or the viewing statistics of other viewers having a similar demographic profile, market segment profile, connection type and/or device type as the user. From matches between the user's behavior and that of other viewers, channels and/or content that is not watched at all by the user or not regularly watched by the user, but that may be of interest the user, may be ascertained. For example, it may be determined that the user regularly watches CNN news and that others who watch CNN news also watch BBC news or it may be determined that BBC news may be an alternative to CNN news in markets where CNN news is not available.

The matching can use data regarding what the user has selected to watch in the past and mapping those selections to selections of others. The mapping may be made on the basis of channel and/or content. For example, if the user watches sports and cooking channels/shows, the matching algorithm may search for the viewing habits of others who demonstrate a propensity to watch sports and cooking channels/shows. This may reveal that a certain dramatic program is popular among these individuals or that a particular news channel is popular among these individuals. In one embodiment, the building of the database in block 62 places each content choice of all the monitored viewers into a category from a predetermined set of categories. Using statistical analysis of the categorized viewing habits, content selection patterns for subgroups of viewers may be ascertained. Each content selection pattern may be indicative of one or more categories frequently selected by a subgroup of the monitored viewers. Using the frequency with which the user selects channels and/or content from certain categories, a match may be made to one or more of the content selection patterns.

Proceeding to block 68, the channel recommendation function 22 and/or the channel recommendation support function 60 may recommend channels of interest to the user. The recommending of block 68 may include transmitting a recommendation from the server 58 to the mobile telephone 10 and/or displaying the recommendation on the display 14 of the mobile telephone.

The recommendation may be made on a general basis or based on content available at a certain time. Since the recommendation may be based on statistical data derived from the user's behavior and the behavior of others, it is contemplated that the recommended channel and/or content will contain a selection that the user may enjoy viewing. A recommendation may be phrased to draw a connection with a channel or content known to be viewed by the user. An example viewing suggestion may be: “since you like to watch Aktuellt, you might like to watch BBC news as well.” Aktuellt is a Swedish news program.

It is contemplated that the recommendations may assist the user choose from an extensive supply of mobile television channels, or, more generally, content from multiple content choices. In addition, the recommendations may assist the user choose a channel when traveling to a location where the user is unfamiliar with the available channels. Thus, the recommendations may function as an intelligent television guide (or, more generally, an intelligent media guide). Recommendations may be offered to the user at selected times. Example times to present recommendations may be when launching a mobile television viewing program, switching channels, at the end of broadcast (e.g., to suggest what the user may wish to view next), at the time a broadcast is starting (e.g., to suggest an alternative to what the user may be currently watching) and so forth.

Recommendations may be made upon user request. The user may request channels and/or shows that may be of interest to the user for a certain date and time. Other requests may be formatted to request channels and/or shows within a particular category (e.g., sports, dramas, movies, news, etc.) that may be of interest to the user.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of making a user specific media content recommendation to a user of a mobile radio terminal that is configured to receive media content, the media content made available by a media content provider to plural mobile radio terminals, comprising:
monitoring content selection behavior of a group of content consumers for the media content using respective mobile radio terminals, and building a database of content selection patterns;
monitoring content selection behavior of the user and establishing a user content selection pattern; and
matching the user content selection pattern to a content selection pattern from the database of content selection patterns, and generating the user specific media content recommendation from the matched content selection pattern, wherein the content recommendation identifies content selected by content consumers associated with the matched content selection pattern.

2. The method of claim 1, further comprising transmitting the content recommendation to the mobile radio terminal of the user.

3. The method of claim 1, wherein the media content is mobile television channels and the monitoring of user and group content selection behavior monitors channel viewing choices.

4. The method of claim 1, wherein building the database places each content selection into one of a predetermined set of content categories and each content selection pattern is indicative of one or more categories frequently selected by a subgroup of content consumers.

5. The method of claim 4, wherein the recommendation identifies an alternative content for content selected by the user and the alternative is categorized in the same category as the content selected by the user.

6. The method of claim 4, wherein the recommendation identifies content from a category different than a category for content selected by the user.

7. The method of claim 1, wherein the mobile radio terminal of the user is a mobile telephone.

8. The method of claim 7, wherein the mobile telephone includes an IP datacast compatible receiver.

9. The method of claim 1, wherein the matching includes matching the user content selection pattern to a content selection pattern associated with media consumers having at one of a demographic profile, a market segment profile, a connection type or a device type that overlaps with a corresponding demographic profile, market segment profile, connection type or device type of the user.

10. A program stored on a machine usable medium for making a user specific media content recommendation to a user of a mobile radio terminal that is configured to receive media content, the media content made available by a media content provider to plural mobile radio terminals, the program comprising executable logic to:
monitor content selection behavior of a group of content consumers for the media content using respective mobile radio terminals, and build a database of content selection patterns;
monitor content selection behavior of the user and establish a user content selection pattern; and
match the user content selection pattern to a content selection pattern from the database of content selection patterns, and generate the user specific media content recommendation from the matched content selection pattern, wherein the content recommendation identifies content selected by content consumers associated with the matched content selection pattern.

11. The program of claim 10, further comprising logic to transmit the content recommendation to the mobile radio terminal of the user.

12. The program of claim 10, wherein the media content is mobile television channels and the logic to monitor user and group content selection behavior monitors channel viewing choices.

13. The program of claim 10, wherein the logic to build the database places each content selection into one of a predetermined set of content categories and each content selection pattern is indicative of one or more categories frequently selected by a subgroup of content consumers.

14. The program of claim 13, wherein the recommendation identifies an alternative content for content selected by the user and the alternative is categorized in the same category as the content selected by the user.

15. The program of claim 13, wherein the recommendation identifies content from a category different than a category for content selected by the user.

16. The program of claim 10, wherein the mobile radio terminal of the user is a mobile telephone.

17. The program of claim 10, wherein the matching logic matches the user content selection pattern to a content selection pattern associated with media consumers having at least one of a demographic profile, a market segment profile, a connection type or a device type that overlaps with a corresponding demographic profile, market segment profile, connection type or device type of the user.

18. A server configured to make a user specific media content recommendation to a user of a mobile radio terminal that is configured to receive media content, the media content made available by a media content provider to plural mobile radio terminals, the server comprising a processor that executes logic to:
monitor content selection behavior of a group of content consumers for the media content using respective mobile radio terminals, and build a database of content selection patterns;
monitor content selection behavior of the user and establish a user content selection pattern; and
match the user content selection pattern to a content selection pattern from the database of content selection patterns, and generate the user specific media content recommendation from the matched content selection pattern, wherein the content recommendation identifies content selected by content consumers associated with the matched content selection pattern.

19. The server of claim 18, wherein the media content is mobile television channels and the logic to monitor user and group content selection behavior monitors channel viewing choices.

20. The server of claim 18, wherein the logic to build the database places each content selection into one of a predetermined set of content categories and each content selection pattern is indicative of one or more categories frequently selected by a subgroup of content consumers.
